(19) United States
(12) Patent Application Publication
(10) Pub. No.: US 2002/0176915 A1
(43) Pub. Date: Nov. 28, 2002

(54) Method for preparing an improved sushi rice with an extended shelf life and sushi rice produced thereby

(76) Inventors: Laura Ellis, Sun Valley, CA (US); Mary DeMartinis, Sun Valley, CA (US)

Correspondence Address: Daniel L. Dawes, Esq., MAYERS, DAWES & ANDRAS LLP, Suite 1150, 19900 MacArthur Boulevard, Irvine, CA, 92612, US

(21) Appl. No.: 09/865,255

(22) Filed: May 25, 2001

(51) Int. Cl. A23K 3/00

(52) U.S. Cl. 426/324

(57) ABSTRACT

A packaged rice foodstuff is prepared by the steps of selecting rice having an average kernel size about a predetermined minimum, removing excess starch from the rice and cooking the rice. The rice is cooled. The pH of the cooled rice is adjusted to form an adjusted rice mixture. The rice mixture is then formed into a shape for inclusion into the packaged rice foodstuff. The step of adjusting the pH of the cooled rice comprises cutting in a seasoned vinegar mixture. The seasoned rice vinegar comprises a mixture of sugar, salt and rice vinegar, and more particularly a mixture of approximately 7 parts sugar, ½ part salt and 10 parts rice vinegar by volume. The invention can also be characterized as an improvement in packaged rice foodstuff prepared by the foregoing method.

### BACKGROUND OF THE INVENTION

1. Field of the Invention

The invention relates to the field of food preparation and in particular to the preparation of rice for use in sushi.

2. Description of the Prior Art

Sushi has typically been prepared fresh at the site of consumption. Sushi bars around the world had been made famous for the preparation of their sushi foodstuffs in the restaurant and in front of the customer. However, preparation of sushi for sale within markets delayed by a several days between the time of preparation and the time of consumption presents new problems for sushi foodstuffs not previously encountered in the traditional service setting. In particular the shelf life of the rice base upon which the meat or vegetable is combined or incorporated presents particular problems. Typically, rice prepared for packaged sushi will in a number of days either become mushy or discolored or both. This has substantially prevented the introduction of sushi as a packaged foodstuff in supermarkets. The expected shelf life of packaged sushi is three or four days before degradation in texture, appearance or taste begins to occur. A short shelf life of the packaged sushi foodstuffs has thus prevented packaged sushi from being widely accepted in retail markets.

Therefore, what is needed is a method and apparatus for preparing sushi, and in particular the rice which accompanies the sushi foodstuffs which has extended shelf life without degradation.

### BRIEF SUMMARY OF THE INVENTION

The invention is a method of preparing packaged rice foodstuff, such as sushi products comprising the steps of selecting rice having an average kernel size about a predetermined minimum, removing excess starch from the rice and cooking the rice. The rice is cooled without substantially altering the average kernel size. The pH of the cooled rice is adjusted to form an adjusted rice mixture. The rice mixture is then cured for a predetermined time. The rice mixture is then formed into a shape for inclusion into the packaged rice foodstuff.

The step of selecting rice having an average kernel size about a predetermined minimum selects rice with an average minimum length of not less than 3/32 inch.

The step of removing excess starch from the rice comprises soaking the rice in water for 12 hours and draining the water from the rice without substantially reducing the average kernel size.

The step of cooking the rice comprises cooking the rice in a water and oil mixture, or more particularly a water and vegetable oil mixture. The rice, water and vegetable oil mixture comprises 10 parts rice and water and 1 part vegetable oil mixture by volume.

The step of cooking the rice in a water and oil mixture comprises bringing the rice, water and oil mixture to boiling in approximately 20 minutes and then boiling the rice, water and oil mixture for 40 minutes.

The step of cooling the rice without substantially altering the average kernel size comprises gently spreading the cooked rice onto a spreading table. The step of gently spreading the cooked rice onto a spreading table comprises spreading the cooked rice onto a thermally conductive table top and gently dividing the cooked rice until room temperature is reached.

The step of adjusting the pH of the cooled rice comprises cutting in an acidic liquid into the cooled rice so that the pH is equal to or less than approximately 4.2. The step of cutting in the acidic liquid into the cooled rice comprises cutting in rice vinegar into the cooled rice. Preferably the step of cutting in the acidic liquid into the cooled rice further comprises cutting in a seasoned vinegar mixture. The seasoned rice vinegar comprises a mixture of sugar, salt and rice vinegar, and more particularly a mixture of approximately 12 parts sugar, 1 part salt and 8 parts rice vinegar by volume. The sugar, salt and rice vinegar mixture is prepared by heating it to almost bring it to a boil and then refrigerating the mixture for at least 24 hours.

The step of curing the rice mixture for a predetermined time comprises returning the cooled, adjusted rice mixture to bulk form and maintaining at room temperature for at least 0.5 hours.

The invention can also be characterized as an improvement in packaged rice foodstuff comprising cooked rice having an average kernel size not less than a predetermined minimum from which excess starch has been removed from the rice and which has had its pH adjusted. The rice has its pH adjusted to be less than or equal to 4.2, and in particular has its pH adjusted by the addition of a mixture of sugar, salt and rice vinegar.

While the method has been described for the sake of grammatical fluidity as steps, it is to be expressly understood that the claims are not to be construed as necessarily limited in any way by the construction of “means” or “steps” limitations under 35 USC 112, but to be accorded the full scope of the meaning and equivalents of the definition provided by the claims whether by the judicial doctrine of equivalents or by statutory equivalents under 35 USC 112. The invention can be better visualized by turning now to the following drawings wherein like elements are referenced by like numerals.

### BRIEF DESCRIPTION OF THE DRAWINGS

FIG. 1 is a simplified flow diagram of the method by which the present invention is practiced.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

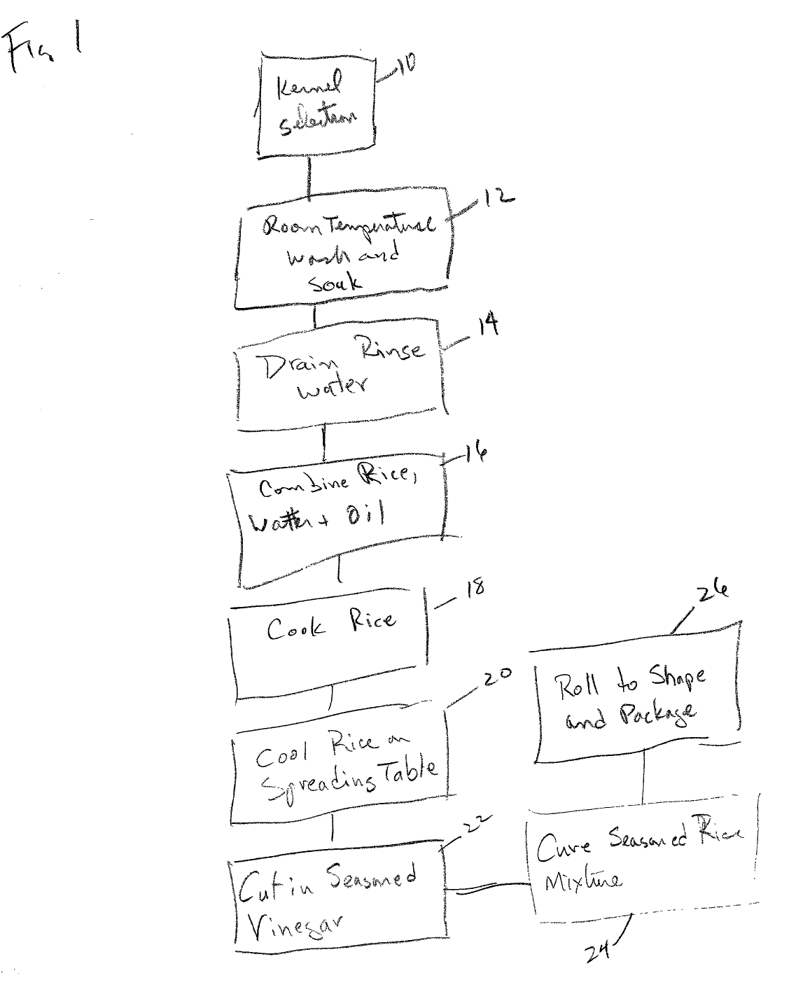

FIG. 1 is a simplified flow diagram which illustrates the primary steps in the method of the invention. Rice is selected in step 10 according to average kernel size, the shorter kernel varieties being avoided. In general, kernels with an average length of not less than 3/32 inch are preferred. Kernel size is a material factor in successful preparation of the sushi rice mixture. After kernel selection is completed in step 10, and the rice is gently washed at step 12 in room temperature water to rid the kernels all of excess starch and others for particles which may have agglomerated to the kernel surfaces. The rice is gently soaked for approximately 12 hours in covered containers at step 12 and then the rinse water is separated from the rice at step 14. Care must be taken at all steps of the process in FIG. 1 to avoid or minimize the breaking or cutting of the kernels.

The rice is returned to cooking pots and covered with water and combined vegetable oil in the amounts of 10 parts rice and water to 1 part vegetable oil by volume at step 16. The rice is then brought to a boil in approximately 20 minutes and then steamed for approximately 40 minutes. Cooking times can be adjusted according to the amounts of rice cooked in each batch and the nature of the rice which varies from season to season.

After being cooked the rice is spread on a metal table or other heat conductive surface at step 20 where it is left to cool to room temperature. The rice is carefully or gently separated or divided to facilitate cooling. However, during the process of dividing, care is again taken to gently handle the rice so that the kernels are not broken or cut.

After the rice has reached room temperature a seasoned vinegar is then cut into it. The seasoned vinegar is not mixed into the rice but cut into it again with care not to break the kernels. The seasoned vinegar is comprised of 7 parts sugar, ½ part salt and 10 parts rice vinegar by volume at step 22. The mixture is brought almost to boiling and then cooled. The mixture is cured while being refrigerated for at least 24 hours before being used.

The seasoned, cooled rice is then taken from the spreading table and returned to covered containers where it is left for approximately 0.5 to 36 hours during which time it is maintained at room temperature, typically between 68 and 70 degrees Fahrenheit. At this point in the process the rice mixture is characterized by a pH level of 4.2 or less. Since the results will vary from batch to batch depending upon the detailed nature of the rice used as the starting component, the pH can be adjusted by varying the amount of vinegar, salt and sugar added to the cooled rice mixture. The pH can be measured by conventional means.

The prepared rice is then cured for a 24-hour period within the covered containers at step 24 at which point it is then ready for loading into appropriate conventional rolling machines at step 26 which will prepare the rice in individual shapes required for sushi preparations. Typically, the rolling machine rolls the sushi into a cylindrical shape into the interior of which meats or vegetables are inserted according to the desired type of sushi. The rice has sufficient adhesiveness so that the rolled cylinder remains intact.

Sushi prepared in this way is characterized by a refrigerated shelf life in the range of 6 to 8 days with no degradation in the quality of its texture, appearance or taste. The food chemistry by the prepared rice achieves substantially longer shelf life is incompletely understood, but the claimed results can be realized by following the above steps and slightly varying when necessary the detailed proportions and times by ordinary trial and error for each rice batch until the claimed results are maximized.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

We claim:

1. A method of preparing packaged rice foodstuff comprising:
selecting rice having an average kernel size about a predetermined minimum;
removing excess starch from said rice;
cooking said rice;
cooling said rice without substantially altering said average kernel size;
adjusting the pH of said cooled rice to form an adjusted rice mixture;
curing said rice mixture for a predetermined time; and
forming said rice mixture into a shape for inclusion into said packaged rice foodstuff.

2. The method of claim 1 where selecting rice having an average kernel size about a predetermined minimum selects rice with an average minimum length of not less than 3/32 inch.

3. The method of claim 1 where removing excess starch from said rice comprises soaking said rice in water for 12 hours and draining said water from said rice without substantially reducing said average kernel size.

4. The method of claim 1 where cooking said rice comprises cooking said rice in a water and oil mixture.

5. The method of claim 4 where cooking said rice in a water and oil mixture comprises cooking said rice in a water and vegetable oil mixture.

6. The method of claim 5 where cooking said rice in a water and vegetable oil mixture comprises cooking said rice in a water and vegetable oil mixture characterized by 10 parts rice and water and 1 part vegetable oil mixture by volume.

7. The method of claim 4 where cooking said rice in a water and oil mixture comprises bringing said rice, water and oil mixture to boiling in approximately 20 minutes and then steaming said rice, water and oil mixture for 40 minutes.

8. The method of claim 1 where cooling said rice without substantially altering said average kernel size comprises gently spreading said cooked rice onto a spreading table.

9. The method of claim 8 where gently spreading said cooked rice onto a spreading table comprises spreading said cooked rice onto a thermally conductive table top and gently dividing said cooked rice until room temperature is reached.

10. The method of claim 1 where adjusting said pH of said cooled rice comprises cutting in an acidic liquid into said cooled rice so that said pH is equal to or less than approximately 4.2.

11. The method of claim 10 where cutting in said acidic liquid into said cooled rice comprises cutting in rice vinegar into said cooled rice.

12. The method of claim 10 where cutting in said acidic liquid into said cooled rice further comprises cutting in a seasoned vinegar mixture.

13. The method of claim 12 where cutting in said seasoned vinegar mixture into said cooled rice comprises cutting in seasoned rice vinegar into said cooled rice.

14. The method of claim 13 where cutting in seasoned rice vinegar into said cooled rice comprises cutting in a mixture of sugar, salt and rice vinegar.

15. The method of claim 14 where cutting in a mixture of sugar, salt and rice vinegar comprises cutting in a mixture of approximately 7 parts sugar, ½ part salt and 10 parts rice vinegar by volume.

16. The method of claim 14 further comprising preparing said sugar, salt and rice vinegar mixture by heating together to almost bring to a boil and then refrigerating said mixture for at least 24 hours.

17. The method of claim 1 where curing said rice mixture for a predetermined time comprises returning said cooled, adjusted rice mixture to bulk form and maintaining at room temperature for at least 0.5 hours.

18. An improvement in packaged rice foodstuff comprising cooked rice having an average kernel size not less than a predetermined minimum from which excess starch has been removed from said rice and which has had its pH adjusted.

19. The improvement of claim 18 where said rice has its pH adjusted to be less than or equal to 4.2.

20. The improvement of claim 18 where said rice has its pH adjusted by the addition of a mixture of sugar, salt and rice vinegar.
